(19) United States
(12) Patent Application Publication
(10) Pub. No.: US 2019/0350683 A1
(43) Pub. Date: Nov. 21, 2019

(54) MID-GINGIVAL IMPLANT SYSTEM

(71) Applicant: Zimmer Dental, Inc., Carlsbad, CA (US)

(72) Inventors: James N. Kenealy, Palm Beach Gardens, FL (US); Dan P. Rogers, Palm Beach Gardens, FL (US); Esther Moran, Green Acres, FL (US)

(21) Appl. No.: 16/416,117

(22) Filed: May 17, 2019

Related U.S. Application Data
(60) Provisional application No. 62/673,675, filed on May 18, 2018.

(51) Int. Cl. A61C 8/00; A61C 9/00; A61C 13/00

(52) U.S. Cl. CPC A61C 8/0068; A61C 8/0037; A61C 8/008; A61C 2008/0046; A61C 13/0004; A61C 8/0022; A61C 9/0046

(57) ABSTRACT

The present invention provides a mid-gingival dental implant system that includes a dental implant having a threaded body portion and a superstructure extending from a coronal surface of the threaded body portion. The superstructure includes two O-ring housings for housing deformable O-rings. The mid-gingival system can also include two screws. One for screw retained final components and one for cement retained final components.

### CLAIM OF PRIORITY

This application claims the benefit of U.S. Provisional Patent Application Ser. No. 62/673,675, filed on May 18, 2018, the benefit of priority which is claimed hereby, and each of which is incorporated by reference herein in its entirety.

### FIELD

The present invention relates to dental implants and, in particular, to dental implants designed for direct attached to a prosthesis.

### BACKGROUND

Dental implants are medical devices that are designed to replace the function of a tooth root. Following the loss or removal of a tooth the dental implant is surgically implanted into the alveolar bone where various biological processes lead to the development of new bone on the implant surface rendering the device capable of supporting loading forces, including those experienced during mastication.

For most dental implant systems in current use, the implant is only one component required for restoring the function of a lost tooth. Additional components are required to accomplish the restoration. These include devices designed to attach to the dental implant (abutments) and support the dental prosthesis (crown). These implant designs include mechanisms for mating with and securing abutments. These abutments have specific mechanisms for securing to the dental implant and also for attachment of dental prostheses. When properly combined, the implant-abutment-crown assembly is capable of providing the function of a natural tooth for many years.

### OVERVIEW

Medical dentistry is a complex and demanding therapeutic discipline where both functionality and esthetics are required and expected outcomes. Various approaches for producing these safe and effective implant-abutment-crown assemblies have been developed. Some have been successful while others were found to be impeded by material or other limitations. As new technologies become available so do the options for the design and fabrication of implant-based restorations. Some new technologies or materials allow for overcoming the limitations that impeded older designs and restore the promise of benefits from these designs.

Previous approaches have used a transgingival implant, which was impeded by the limitations of contemporaneous technology. The transgingival implant is a one-piece dental implant designed for osseous fixation and to emerge from the bone, extend and emerge from the overlying mucosa (gingival) tissues, and attach to restorative abutments to complete the restoration of chewing function.

The current invention is directed toward a mid-gingival implant system (MGIS) that uses a mid-gingival implant. The mid-gingival implant is designed for osseous fixation and to extend past the bone but is not designed to emerge from the gingiva into the oral cavity. That is, the most coronal dimension of the implant is instead designed to remain below the gingival margin.

Recent developments in digital dentistry have resulted in commercially available devices that provide computer-assisted crown design and milling capabilities for use in the dental clinic. These technologies now allow a dentist to complete the restoration of a dental implant without the involvement of a dental laboratory, which is the traditional resource for design and fabrication of a restorative prosthesis (an abutment and crown). One pivotal component of these developments is the commercial introduction of a “Ti-Base” (titanium based) abutment that enables a dentist to design and attach an office-based milled crown to the dental implant. The Ti-Base abutment is first cemented to the patient-specific CAD/CAM milled crown to form a mesostructure. This mesostructure is then attached to the dental implant using another component: a retention screw. The MGIS is specifically designed for the direct attachment of milled crowns to a dental implant, obviating the need for auxiliary abutments and mesostructures.

The MGIS is a root-form, dental implant system designed with a novel connection mechanism designed for direct attachment of a prosthesis. This is a solid/one-piece implant system with associated components that allow for the safe and effective means for surgical insertion into the alveolar bone ridge. Associated components can include, but are not limited to, healing abutments that are designed for attachment at the time of implant insertion to form and condition the gingiva and prepare it for the subsequent attachment of a prosthesis. In one example, the healing abutment can be a scanning element such that the shape, design, dimensional information, or other special elements on a surface of the healing abutment can be used to facilitate the design and fabrication of a crown. Thus, after a few weeks of implant healing, the information provided by the healing abutment via an intra-oral scan or impression scan can used to design a patient-specific crown, as discussed herein. The crown design is communicated to a milling machine that manipulates pre-formed blocks of dental material (ceramics, polymers) into a tooth-like structure. The healing abutment is then removed, and the crown is attached to the implant, completing the restoration. The MGIS will have specifications that will be supplied to and used by third-party vendors of ceramic blocks to produce blocks specifically designed for fabrication of MGIS crowns. These specifications will direct the prefabrication of blocks with an internal configuration designed to mate with the MGIS superstructure and engage with the various MGIS design elements.

To further illustrate the apparatuses, systems and methods disclosed herein, the following non-limiting examples are provided:

In Example 1, a dental implant system is provided including a dental implant including: a body portion extending from a coronal end to an apical end, the body portion including a thread; a superstructure extending from the coronal end of the body portion, the superstructure including: a coronal O-ring housing; an apical O-ring housing; and a body portion positioned between the coronal O-ring housing and the apical O-ring housing, the body portion including at least one flat surface.

In Example 2, the Example 1 can optionally be configured to include a first O-ring configured to be mounted within the coronal O-ring housing; and a second O-ring configured to be mounted within the apical O-ring housing.

In Example 3, any one or a combination of Examples 1-2 can optionally be configured such that the dental implant includes a threaded bore extending from a coronal surface of the surface structure toward the apical end of the body portion.

In Example 4, any one or a combination of Examples 1-3 can optionally be configured such that the superstructure extends from a coronal surface of the body portion.

In Example 5, any one or a combination of Examples 1-4 can optionally be configured such that a stop surface is formed between an edge of the coronal surface and the superstructure, the stop surface configured to engage an apical end of the final prosthesis.

In Example 6, any one or a combination of Examples 1-5 can optionally be configured such that the final prosthesis is a crown.

In Example 7, any one or a combination of Examples 1-6 can optionally be configured such that at least a surface of the superstructure is roughened via acid-etching.

In Example 8, any one or a combination of Examples 1-7 can optionally be configured such that the body portion of the superstructure includes two flat surfaces.

In Example 9, any one or a combination of Examples 1-8 can optionally be configured such that the two flat surfaces are diametrically opposed to each other.

In Example 10, any one or a combination of Examples 1-9 can optionally be configured such that the retention screw configured to couple a final prosthesis to the dental implant, the retention screw having a head, a shank, and a threaded body configured to engage a threaded bore of the implant.

In Example 11, any one or a combination of Examples 1-10 can optionally be configured such that a short screw configured to plug a threaded bore of the implant when securing a final prosthesis to the dental implant via cement.

In Example 12, any one or a combination of Examples 1-11 can optionally be configured such that the herein the short screw has a length that is less than a length of the retention screw.

In Example 13, any one or a combination of Examples 1-12 can optionally be configured to further include a dental implant analog corresponding to the dental implant; and an indicator tube, the indicator tube having one opening at the coronal end, a plurality of perforations extending from an apical end toward the coronal end, and a plurality of graduated marks, wherein the indicator tube and the dental implant analog can be used to confirm a proper seating of a final prosthesis before coupling the final prosthesis to a patient.

Example 14 provides a dental implant system including a dental implant including a dental implant including a threaded body portion; and a superstructure extending from the body portion, the superstructure including two O-ring housing spaced apart by a body portion including two flat surfaces.

In Example 15, Example 14 can optionally be configured to include a first O-ring configured to be mounted within a first O-ring housing of the two O-ring housings; and a second O-ring configured to be mounted within a second O-ring housing of the two O-ring housings.

In Example 16, any one or a combination of Examples 9-15 can optionally be configured to include a first screw configured to be used to couple a final prosthesis to the dental implant; and a second screw configured to be used when a final prosthesis is coupled to the dental implant via cement, wherein one or more dimensions of the first screw are different form the second screw.

In Example 17, any one or a combination of Examples 9-15 can optionally be configured such that the implant actuator handle portion is configured to include a dental implant analog corresponding to the dental implant; and an indicator tube, the indicator tube having one opening at the coronal end, a plurality of perforations extending from an apical end toward the coronal end, and a plurality of graduated marks, wherein the indicator tube and the dental implant analog can be used to confirm a proper seating of a final prosthesis before coupling the final prosthesis to a patient.

In Example 18, a method installing a dental implant into a jawbone of a patient, the dental implant including: a threaded body portion; and a superstructure extending from the body portion, the superstructure including two O-ring housing spaced apart by a body portion including two flat surfaces, wherein the threaded body portion is positioned within bone and the superstructure is positioned beneath a top gingival surface; attaching a healing abutment to the dental implant, the healing abutment including information that allows identification of at least two characteristics of the dental implant; creating a three-dimensional computer model from a scan of at least a portion of the mouth including the healing abutment; based on the information from the healing abutment, modifying the three-dimensional computer model so as to include a three-dimensional computer model of at least a portion of the dental implant to be used in creating the prosthesis; and designing a three-dimensional computer model of the prosthesis form the modified three-dimensional model.

In Example 19, Example 18 can optionally be configured such that the portion of the three-dimensional computer model of at least the portion of the dental implant includes the superstructure and a coronal surface of the threaded body portion.

In Example 20, any one or a combination of Examples 18 and19 can optionally be configured such that transmitting at least a portion of the designed three-dimensional computer model of the prosthesis to a milling machine capable of producing at least a portion of the prosthesis.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A illustrates a side view of a mid-gingival implant (also referred to herein as “implant”), according to some example embodiments.

FIG. 1B illustrates a side view of a portion of the mid-gingival implant in FIG. 1A rotated 180 degrees.

FIG. 2 illustrates a top-down view of the mid-gingival implant in FIGS. 1A and 1B.

FIG. 3 is a cross-sectional view of the mid-gingival implant shown in FIG. 1A.

FIG. 4 illustrates a perspective view of a portion of the mid-gingival implant including two O-rings, according to some example embodiments.

FIG. 5A illustrates a perspective view of an O-ring, according to some example embodiments.

FIG. 5B illustrates a top-down view of the O-ring in FIG. 5A.

FIG. 6A illustrates a side-view of a retention screw to be used with the mid-gingival implant, according to some example embodiment.

FIG. 6B illustrates a top-down view of the retention screw in FIG. 6A.

FIG. 7A illustrates a short screw to be used with the mid-gingival implant, according to some example embodiments.

FIG. 7B illustrates a top-down view of the short screw in FIG. 7A.

FIG. 8 illustrates a cross-sectional view of the mid-gingival implant coupled to a healing abutment via the retention screw, according to some example embodiments.

FIG. 9 illustrates a cross-sectional view of the mid-gingival implant coupled to a final prosthesis via the retention screw, according to some example embodiments.

FIG. 10 illustrates a cross-sectional view of the mid-gingival implant coupled to a final prosthesis with cement, according to some example embodiments.

FIG. 11 illustrates a perspective view of a dental analog for designing a final prosthesis to be coupled to the mid-gingival implant, according to some example embodiments.

FIG. 12 illustrates a side view of a crown seating indicator to be used when coupling the final prosthesis to the mid-gingival implant, according to some example embodiments.

FIG. 13 illustrates a cross-sectional view of the final prosthesis being coupled to the mid-gingival implant using cement and the crown seating indicator, according to some example embodiments.

### DETAILED DESCRIPTION

Specific embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention.

The following description focuses on embodiments of the present invention applicable to a dental implant, and in particular to a one-piece mid-gingival dental implant (referred to herein as “mid-gingival implant” and “implant”). However, it will be appreciated that the invention is not limited to the embodiments focused on in this application. The present invention provides an implant that is specifically designed for direct attachment of CAD/CAM milled crowns. The MGIS includes design elements that obviate the need for an additional, auxiliary dental devices otherwise required to enable attachment of a CAD/CAM milled crown to a dental implant. The design elements also obviate the need for extra-corporeal assembly of the auxiliary dental devices and final prosthesis.

For direct attachment of the milled crown to the implant, preventing cement extrusion (when using cement retention) can be important. For example, securing components without using a screw, generally dental cements such as, but not limited, epoxy or similar, are used for establishing and maintaining the attachment of the final prosthesis to the implant. However, exposure of the dental cements to the surrounding gingiva can cause inflammation to the gingiva that can lead to serious disease. Therefore, the present invention provides an implant system that can minimize or prevent extrusion of cements from within the interior of the implant and final prosthesis.

Two-piece dental implant systems have internal void spaces that have been found to harbor microbes and to release microbial-generated toxins into the body. The two-piece dental implant systems have an implant-abutment microgap through which microbes may pass into and colonize within these implant void spaces. Microbial products leave the void spaces and exit the microgap causing local and systemic toxicity. The MGIS of the present invention can prevent or minimize microbial exudates. For example, as discussed herein, the MGIS has unique design elements that are specifically designed to prevent the ingress and colonization of microbes.

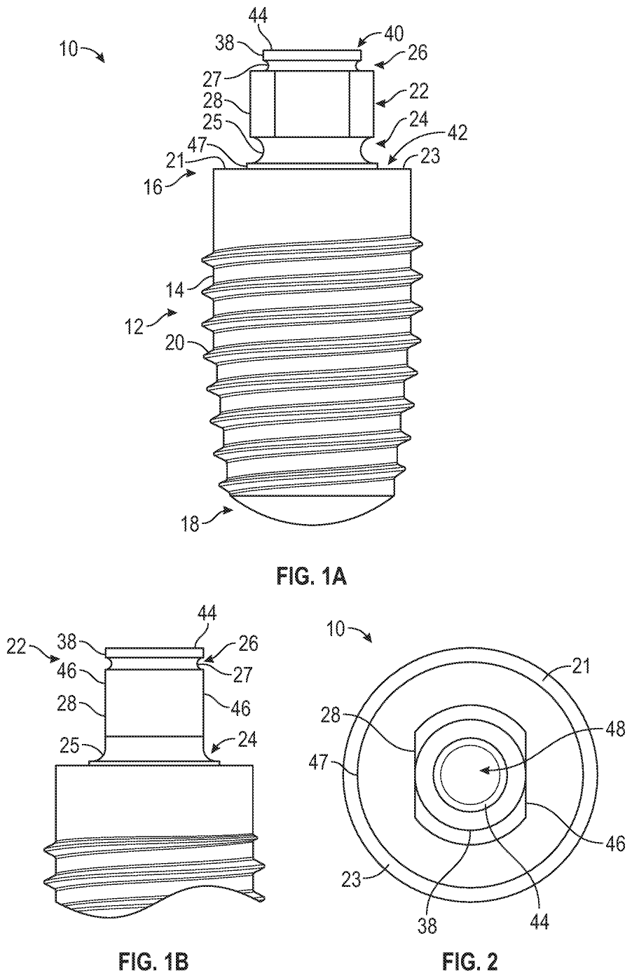

As seen in FIG. 1A, the implant 10 includes an implant body 12 and a superstructure 22. The implant body 12 is the region of the device designed for insertion into and to reside in the alveolar bone providing an anchoring support for the final prosthesis (e.g., crown). In one example, the superstructure 22 resides above the bone and inside the gingiva. For example, the superstructure 22 can extend above the bone but beneath the gingival surface. However, in some examples, the superstructure 22 can extend beyond the gingival surface and still maintain the benefits provided herein of the implant 10. The superstructure 22 is an integral part of the implant and is designed to mate with the final prosthesis. While having the superstructure 22 integral with the implant body 10 can simplify manufacturing and minimize the number of components needed, the superstructure 22 is also contemplated as being a separate component that can be coupled to the implant body 22. For example, the dimensions (width, height, etc.) of the superstructure 22 may vary depending on the patient, surgical area, type of implant, and tooth being replaced. Thus, in one example, a plurality of superstructures 22 (each having different dimensions) can be provided that can be coupled to the implant body 12. In one example, a plurality of implants 10 can be provided to a user, where each implant 10 of the plurality of implants 10 includes a superstructure 22 having different dimensions from other superstructures 22.

In one example, the implant 10 can be made of a metal selected from titanium, tantalum, cobalt, chromium, stainless steel, and alloys thereof. Other known materials for forming dental implants be utilized. In one example, a portion of or the entire surface of the implant 10 can undergo processing to roughen the surface of the implant 10. In one example, the surface of the implant 10 can undergo chemical processing, e.g., acid-etching, to roughen the surface. In one example, at least the superstructure 22 has an acid-etched surface with a surface topography that promotes the adhesive strength of applied cement for promoting final prosthesis attachment. In one example, the implant body 12 and the superstructure 22 can have the same surface topography. In another example, the implant body 12 and the superstructure 22 can have different surface topographies from each other. Moreover, the implant body 12 can have the one surface topography or can have varying surface topographies. Similarly, the superstructure 22 can have one surface topography or can have varying surface topographies. The surface topography can include microscale roughness, nanoscale roughness, and combinations thereof. The various topographies can be formed using various techniques known in the art.

The implant body 12 extends from a coronal end 16 to an apical end 18. The implant body 22 defines a coronal surface 21 from which the superstructure 22 extends. The surface 14 of the implant body 12 can include threads 20. The design of the implant body 12 can vary. It is contemplated that the implant body 12 can include various features. For example, the type, number, and size of the threads 20 can vary and any cutting elements or cutting flutes to assist in inserting the implant 10 can be utilized. Further, the implant body 12 can taper, be cylindrical, or other and the threads 20 can taper, have a constant diameter along the length of the implant body 12, or other.

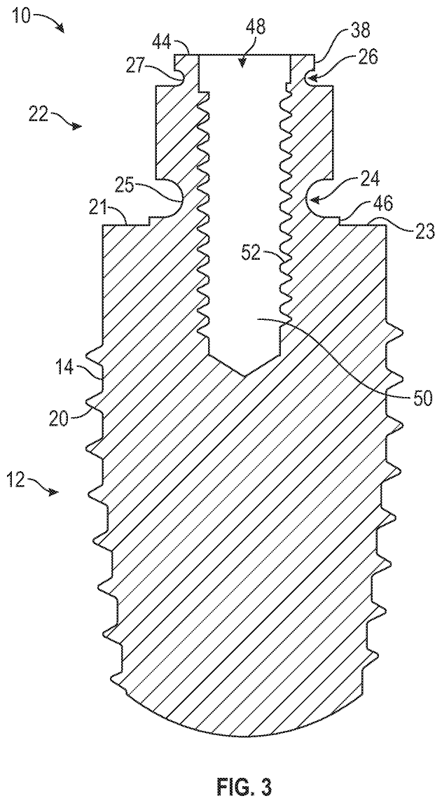

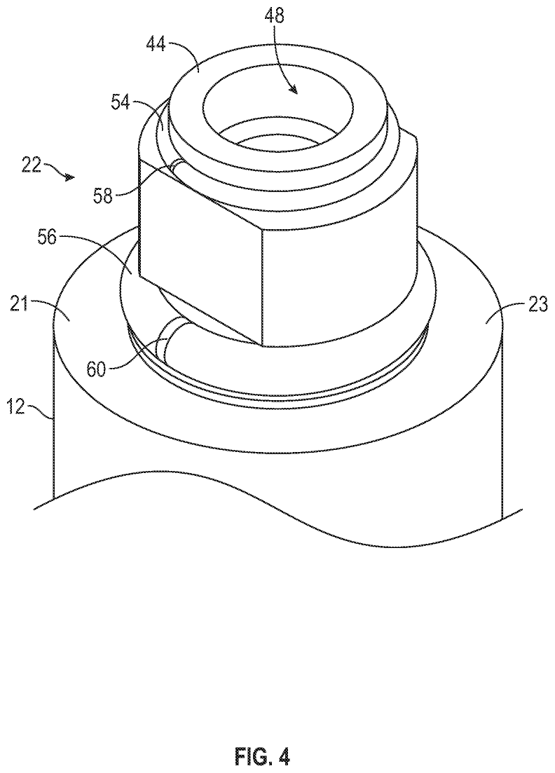

Referring to FIGS. 1-3 the superstructure 22 extends from the coronal surface 21 of the implant body 12. A stop surface 23 is defined on the coronal surface 21. The stop surface 23 on the coronal surface 21 of the implant body 12 can provide a specific landmark for placing a final prosthesis (e.g., crown). The stop surface 23 limits the apical position of the final prosthesis and allows for accuracy in its design. The positive stop 26 can also provide support of the final prosthesis during loading.

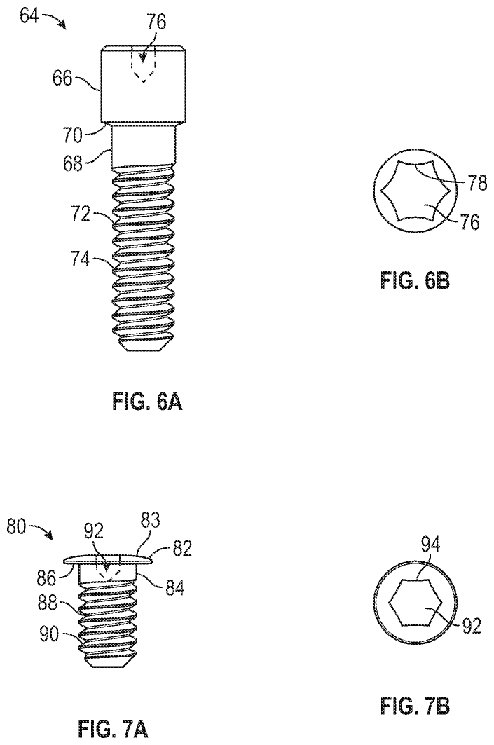

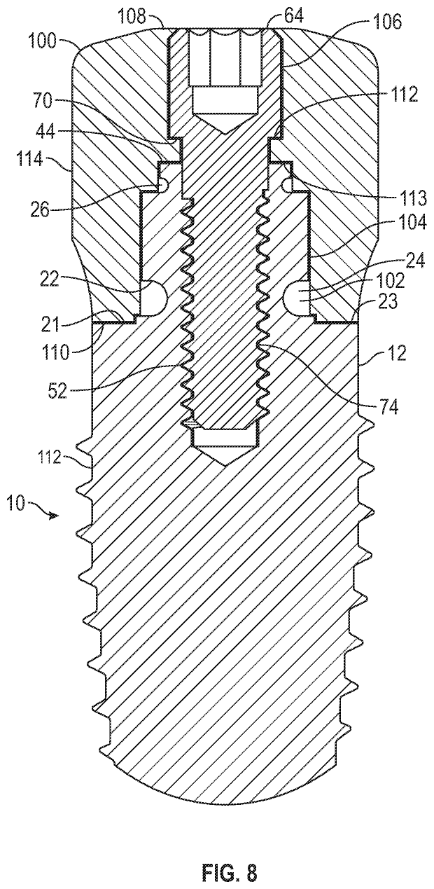

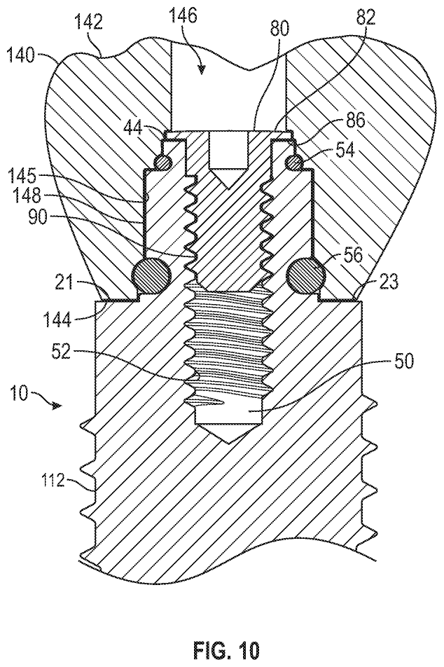

The superstructure 22 extends from a coronal end 40 to an apical end 42. The superstructure 22 includes a body 28, a coronal groove 26, and an apical groove 24. As seen in the figures a coronal extension 28 can be adjacent to the coronal groove 26 and an apical extension 27 can be adjacent to the coronal groove 26. A coronal surface 44 of the superstructure 22 includes an opening 28 to a bore 50 extending from the coronal surface 44 to an internal portion of the implant body 12. The bore 50 can includes threads 52 along a portion of a surface. As discussed herein, the bore 50 can act as a screw chamber and can receive a retention screw 64 (see FIGS. 6, 8, and 9) and the short screw 80 (see FIGS. 7 and 10) for couple a final prosthesis to the implant 10 via screw retention (retention screw 62) or cement retention (short screw 80, which plugs the bore 50). As discussed herein, the geometry of the superstructure 22 can include several design elements for establishing and maintaining the orientation of the final prosthesis.

In one example, the body 28 includes dual flats 46, which are two large flat vertical areas of the superstructure 22 cross-section. The dual flats 46 can assist several functions including, but not limited to, implant insertion, insertional guidance, final prosthesis retention, and rotational stability.

For example, the dual flats 26 can provide a large surface area for applying a torque (rotational) force to the implant 10 to drive the implant threads 20 through the osteotomy wall until the intended depth is attained. In one example, the implant construction can allow for the safe application of insertional forces greater than those possible with two-stage implant systems (greater than 90 Newton Centimeters (Ncm)), which can be required when placing the implant in dense bone conditions.

Additionally, the dual flats 26 can provide guidance to the final prosthesis during insertion to ensure proper orientation of the final prosthesis during attachment. Further, the dual flats 26 can provide a large surface area to oppose rotational forces that can ensure maintenance of correct orientation and function of the final prosthesis during use. The large surface area of the dual flats 26 can also promote cement retention of the final prosthesis.

While shown with dual flats 46, more or less than two flats 46 can be used. For example, depending on the conditions of the patient and tooth being replaced, the number of flats 26 and the area of the flats can be based on the needs of the patient taking into account the benefits provided from the flats 46.

As seen in FIG. 1A, viewing the superstructure from one of the flats 26, a diameter of the coronal extension 38 can be less than the diameter of the body 28. With reference to FIG. 1B, when viewing the superstructure between the two flats 26, the diameter of the coronal extension 38 can be equal to the diameter of the body 28.

Referring to FIGS. 1-4, the coronal groove 26 and the apical groove 24 each have a groove surface 27 and 25, respectively. The coronal groove 26 and the apical groove 24 are integrated structures of the implant that can house O-rings (e.g., O-rings 54 and 56). The O-rings can control the displacement of cement during final prosthesis insertion (for cemented retention) and prevent ingress and movement of microbes that may have gained access into the implant system. These O-rings 54, 56 can be made of malleable metal, such as, for example, silver (Ag). The dimensions of the O-rings 54, 56 are such that the O-rings 54, 56 will be deformed as the final prosthesis is seated upon the superstructures 22. This metallic deformation can serve to fill local void spaces and eliminate openings at those junctions. Each O-ring 54, 56 can have a small discontinuity 58, 60 that will allow the ring to expand for insertion into its respective groove.

In one example, the groove surfaces 25, 27 can be curved, e.g., concave. In one example, the groove surface 27 of the coronal groove 26 is smaller than the groove surface 25 of the apical groove 24. Therefore, in one example, the O-ring 54 can have one or more dimensions that are smaller as compared to the dimensions of the O-ring 56. As seen in FIG. 1B, the groove surface 25 of the apical groove 24 has a diameter that initially equals the diameter of the body 28 and then tapers away until the edge of the apical extension 47. The groove surfaces 25, 27 can have a radius of curvature that is constant or that varies. While shown as being concave, the shape of the groove surfaces 25, 27 can be designed with the dimensions of O-rings 54, 60, such that when the final prosthesis is seated, the O-rings 54, 60 provide enough deformation to fill any void spaces.

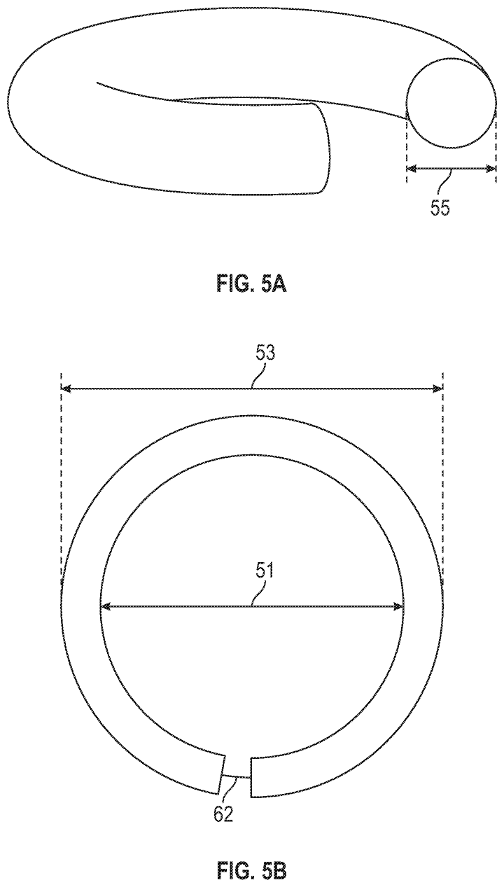

FIGS. 5A and 5B illustrate an example of an O-ring. As discussed herein, the dimensions of the O-rings can be based on a variety of factors including the dimensions of the apical groove 24 and the coronal groove 26. Each O-ring can have a length 62 of the discontinuity that enables the O-ring to be placed in the grooves. The length 62 can be such that the O-ring can expand enough to be placed into the groove. Additionally, each O-ring will have a cross-sectional diameter 55, an outer diameter 53, an inner diameter 51, and a cross-sectional shape. In one example, the O-ring 54 (coronal O-Ring) can have a cross-section dimeter of 0.02 Below is Table 1 that illustrates one example of the dimensions of the O-rings 54, 56; however, other dimensions are contemplated and can be based on various factors. Table 1 below illustrates one example for the dimensions of O-ring 54 and O-ring 56:

TABLE 1
O-Ring Dimensions

| | O-Ring 54 | O-Ring 56 |
|---|---|---|
| | (Coronal O-ring) | (Apical O-ring) |
| Cross-sectional Diameter | 0.505 mm | 0.505 mm |
| millimeters (mm) | | |
| Inner Diameter (mm) | 2.794 mm | 4.801 mm |
| Outer Diameter (mm) | 3.810 mm | 5.816 mm |

As discussed above, preventing or minimizing cement extrusion out of the crown margin onto the exterior of the implant is important for preventing cement-induced gingival inflammation. The apical O-ring 56 is designed to block the apical movement of cement material and re-direct it in the coronal direction. Further, as discussed above, prevention of microbial ingress is important and the deformed O-rings after the final prosthesis is seated can occupy any voids that may exist inside the final prosthesis-implant interfaces, e.g., crown-implant interface. That is, the coronal O-ring 54 can block microbial ingress from the bore 50 (e.g., screw retention chamber) and the apical O-ring 56 can block microbial ingress from the crown margin.

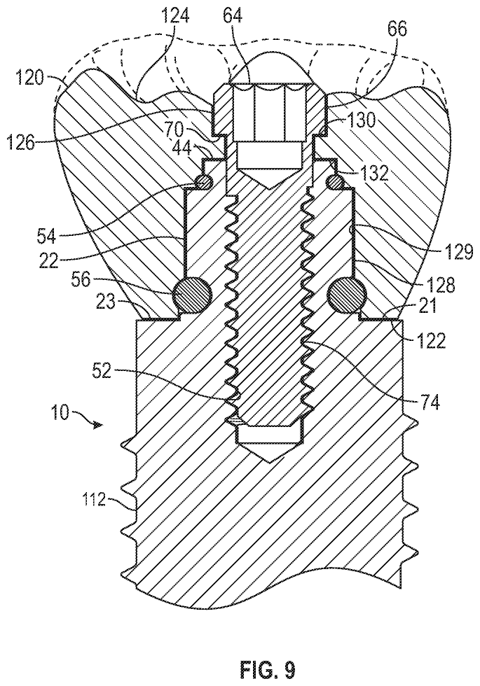

FIGS. 6A and 6B illustrate a retention screw 70 that can be used to secure a healing abutment (see FIG. 8) or secure a final prosthesis (e.g., crown) to the implant 10 (see FIG. 9) and FIGS. 7A and 7B illustrate a short screw 80 that can be used when a final prosthesis is coupled to the implant 10 via cement (see FIG. 10). The retention screw 64 is designed for screw-retention cases where the purpose of the retentions screw 64 is to secure the final prosthesis or healing abutment to the implant. The retention screw includes a head 66, a shank 68, and body 72 including threads 74. A stop surface 70 can be defined between the head 66 and the shank 68 and is configured to contact a stop surface 112 of the healing abutment 100 (see FIG. 8) or contact a stop surface 130 in the final prosthesis 120 (see FIG. 9). In an example, the head 66 and the shank 68 do not includes threads. A driving bore 76 is provided at the coronal end of the retentions screw 64 and includes a non-rotational interface 78 that can receive a device (e.g., driver) to apply rotational force to the screw.

The retention screw 64 can prevent or minimize the damage to the final prosthesis, e.g., crown. That is, the retention screw 64 can prevent or minimize the crown form shattering or from microfractures that may occur when metal is in direct contact with the materials used to fabricate crowns (such as, e.g., ceramics, zirconia). Further the retention screw 64 can prevent or minimize microbial ingress into the bore 50 of the implant 10. To address these two functions the retention screw 64 can be made from stainless steel. In one example, using conventional metallurgical processes the steel foundation will be plated with elemental silver (Ag) and gold (Au). For example, multiple layers of malleable metal (Ag—Au—Ag) can be plated onto the retention screw in the region of the head 66, the shank 68, and a coronal portion of the threads 74. Layering of these malleable metals on the steel foundation of the retention screw 64 produces a “softer” surface for engaging the final prosthesis. This can dissipate the peak stress forces at the interface with the final prosthesis. By buffering the peak stress force, the retention screw 64 can prevent and minimize the final prosthesis material from shattering or from developing microfractures.

The short screw 80 is designed for cement-retained cases where the purpose of the short screw 80 is to seal the bore 50 (see FIG. 10) and provide a means of dislodging the final prosthesis, if needed, as discussed herein. The short screw 80 includes a head 82 with a top surface 83, a shank 84, and a body 88 including threads 80. A stop surface 86 is defined between the head 82 and the shank 84 and is configured to contact the coronal surface 44 of the implant when seated (see FIG. 10). In one example, the head 82 and shank 84 do not include threads. A driving bore 92 is provided at the coronal end of the short screw 80 and includes a non-rotational interface 94 that can receive a device (e.g., driver) to apply rotational force to the screw. As seen in FIGS. 6 and 7, the short screw 80 has a length that is less than a length of the retention screw 64. However, varying lengths of the retention screw 64 and short screw 80 are contemplated.

As discussed, the short screw 64 is used for cement-retained crowns where the retention screw 64 will not be used. Without the use of the retention screw 64 a large void remains within the bore 50. To eliminate this space from microbial colonization the short screw 80 is configured to seal the bore 50 and also assist the removal of the final prosthesis should the need arise. The short screw 80 is fabricated from stainless steel with some of its surface plated with multiple layers of malleable metal (Ag—Au—Ag). For example, the head 82, the shank 84 and a coronal portion of the threads 90. The short screw 80 can be inserted into place prior to attaching the final prosthesis. Near completion of inserting the short screw 80, the coronal threads containing multiple layers of malleable metal can deform as increasing force is required for the short screw 80 to be rotated into its final position. The tight tolerances in the bore 50 will cause the metal to deform and occlude the helical void that would otherwise form in the screw chamber and in doing so eliminate pathways for microbes.

Blocks manufactured for use in Ti-Base abutments (as in the previous approach) are provided with a pre-fabricated hollow central channel. This channel is intended to provide means to insert a retention screw for the finished milled crown. For cement retained cases this channel is not used and is filled with a UV cured polymer and sealed. For cement retained crown cases the short screw 80 will be used to seal-off the entrance to the chamber. It is placed before the attachment of the final prosthesis. As seen in FIG. 10, the head 82 of the short screw 80 has a larger outer diameter than the crown's central channel 145. Should the need arise to remove the cemented crown 140 the short screw 80 can be employed to apply liberation force (opposite of retention force) onto the crown 140 to help break the cement bond and remove the crown 140.

FIG. 8 illustrates the implant 10 coupled to a healing abutment 100. As seen in FIG. 8, the healing abutment 100 can include a bore 102 including a screw chamber 106 and an implant chamber 104. Once seated, an apical surface 110 of the healing abutment 100 contacts the coronal surface 21 along the stop surface 23 of the implant body 12. The superstructure 22 can be positioned within the implant chamber 104. While shown without the O-rings, the O-rings can be positioned within the grooves 24, 26 while the healing abutment is attached to the implant 10. As discussed herein, the healing abutment 100 can be used as a scanning member to assist in designing the final prosthesis. For example, Encode® healing abutments from Zimmer Biomet can be used. The shape of healing abutment 100 can be used or surfaces of the abutment 100 can be used to provide information in the scan data to digitally design the final prosthesis. In one example, side surface 114 and/or top surface 108 can include markings that, when scanned, can provide information such that the digital data can be modified and design the final prosthesis.

In one example, a method for creating a prosthesis for mating with the dental implant in the mouth of the patient can include creating a three-dimensional computer model from a scan of at least a portion of the mouth, the mouth including gingival tissue, and the healing abutment coupled to the dental implant. The healing abutment 100 can include identifying features (e.g., markings, shape, text, other) that indicates information regarding characteristics of the dental implant. Based on the information indicated from the healing abutment 100, the three-dimensional computer model can be modified to include a three-dimensional computer model of at least a portion of the dental implant to be used in creating the prosthesis. In one example, this can include the coronal surface 21 of the implant 10 and the superstructure 22. Once the three-dimensional data is modified, a three-dimensional computer model of the prosthesis can be designed.

In one example, a scanner can simply take the necessary information directly from the mouth of a patient without the need for impression material whatsoever. The information from of the healing abutment provide the required information to design the final prosthesis. Instead of a scanner, an impression of the mouth can be taken with the healing abutment mounted on the implant. The impression process creates a “negative” image of the healing abutment. A corresponding mold is created from the impression. This mold, or a stone model created from the mold, can then be scanned. A computer program is able to create a three-dimensional perspective of the relevant jaw section of the patient, including the implant and healing abutment. Due to the identifying features of the healing abutment now present in the mold, the computer program is able to accurately analyze and produce the appropriate dimensions so that the final prosthesis can be designed.

This system allows the dentist to produce the permanent components more quickly because the healing abutment does not have to be removed in order to produce the permanent dental components. In other words, the second step of taking an impression with an impression coping is eliminated. The dentist also does not have to confront the difficulties of gingival closure that appear when a healing implant is removed. Finally, the patient is not forced to endure the somewhat painful procedure of healing abutment removal. With the procedure of the present invention, the removal of the healing abutment can occur during the same surgery as the installation of the permanent components. Once the permanent prosthesis has been designed, the information can be sent to a milling machine to fabricate the final component to be attached to the implant 10.

FIG. 9 illustrates a final prosthesis (e.g. a crown 120) attached to the implant 10. The crown 120 has a tooth-like shape 120 and is configured to be directly attached to the implant via retention screw 64. Once fully seated, an apical surface 122 of the crown 120 abuts the coronal surface 21 along the stop surface 23 of the implant body 12. As seen, O-rings 54, 56 are positioned within the grooves of the superstructure 22. While illustrated for clarity, the deformation of the O-rings 54, 56 is not fully illustrated. The crown 120 includes a bore 128 and includes an implant portion 129 and a screw portion 126. As seen in FIG. 9, the bore 128 defines a bottom stop surface 132 and a top stop surface 130. The bottom stop surface 132 can contact the coronal surface 44 of the superstructure 22 and the top stop surface 130 can contact the shoulder 70 of the retention screw 64.

FIG. 10 illustrates a final prosthesis (e.g. a crown 140) attached to the implant 10. The crown 140 has a tooth-like shape 142 and is configured to be directly attached to the implant via cement. As discussed herein, the short screw 80 is inserted into bore 50 before the crown 140 is attached. Once fully seated, an apical surface 144 of the crown 140 abuts the coronal surface 21 along the stop surface 23 of the implant body 12. As seen, O-rings 54, 56 are positioned within the grooves of the superstructure 22. While illustrated for clarity, the deformation of the O-rings 54, 56 is not fully illustrated. The crown 140 includes a bore 146 and includes an implant portion 148 that defines a recess 145 that can receive the short screw 80 and the superstructure 22. As seen in FIG. 10, the diameter of the head 86 of the short screw 80 is greater than the bore 146 at the coronal end 146.

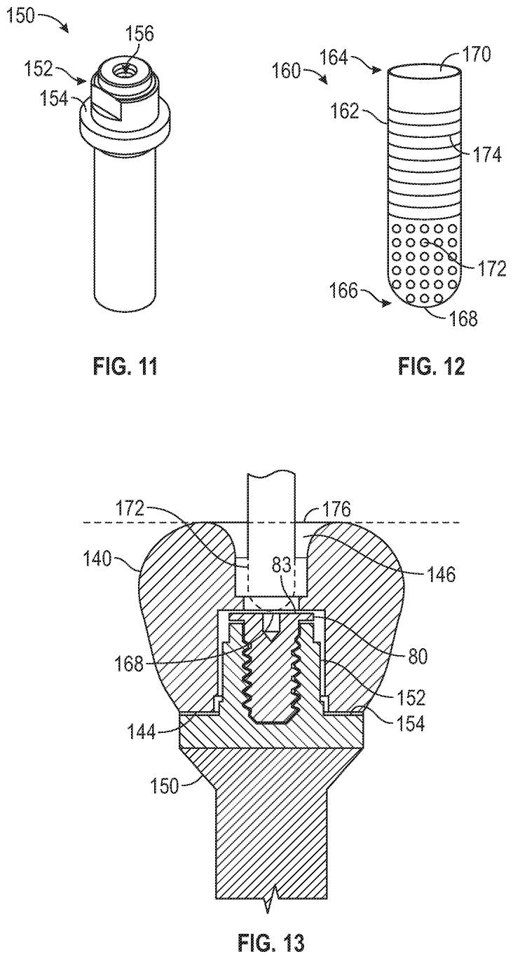

For screw retained crowns the adequacy of crown seating may be confirmed by the amount of torque applied to the retention screw. For cement retained crowns no similar mechanism (retention screw) is available. A mechanism to provide the user with confirmation that the cemented crown has established complete seating on the stop surface 23 (see FIG. 10) can be important. One means of assessing the adequacy of cemented crown fit is to use the MGIS implant analog 150 (hereinafter “analog 150”) illustrated in FIGS. 11 and 13. The analog 150 is a device that has the same appearance and dimensions as the implant implanted into the patient but is not intended for surgical use. The analog 150 is used primarily to test the passivity of fit of a milled crown to ensure that the crown is ready for insertion. The analog 150 can also be used for confirmation of seating as follows. When the milled crown is placed on the analog 150 the top of the analog's short screw 80 (see FIG. 13) is accessible through the bore 146 (see FIG. 10). With the crown fully-seated on the stop surface 154 the distance from the top surface 83 of the short screw 80 to the top of the prepared crown bore 176 can be used as the reference for adequacy of crown seating on the patient's implant.

To use this reference, a crown seating indicator 160 (hereinafter “indicator) shown in FIG. 12 can be used. This indicator 160 can be used for cement retained cases primarily to gather cement that is extruded “upwards” and into the bore 146 and prevents it from attaching to the crown chimney surfaces. The indicator 160 includes a body extending from a coronal end 164 to an apical end 166 and includes a bore 170. The apical end 166 is closed. A portion of the indicator 160 includes perforations 172 that are used to collect any extruded cement to enter the indicator 160. The indicator 160 also includes graduated marks 174 that can be a reference so that a user can mark the position on the indicator 160 that corresponds to the position on top of the crown 140.

This device can also be employed to provide confirmation of the crown 140 seating. For example, when the crown 140 is placed on the analog 150 the tube is inserted and seated on the top surface 83 of the short screw 80. A reference point 168 can be placed onto the short screw 83. In one example, the reference point 168 can be a flat surface. One the graduated mark 174 is marked, the user can apply cement to the crown 140 and is oriented and inserted the implant 10 in the patient including the implant and the short screw. The user applies downward force and uses the marked position on the indicator 160 to confirm that the crown 140 is seated on the stop shoulder 21 on the coronal surface 23 of the implant (see FIG. 10). Once the adequacy of crown 140 insertion is confirmed the indicated 160 is removed and discarded.

Each of the following non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R, § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed:

1. A dental implant system, comprising:
a dental implant including:
a body portion extending from a coronal end to an apical end, the body portion including a thread;
a superstructure extending from the coronal end of the body portion, the superstructure including:
a coronal O-ring housing;
an apical O-ring housing; and
a body portion positioned between the coronal O-ring housing and the apical O-ring housing, the body portion including at least one flat surface.

2. The dental implant system of claim 1, further including:
a first O-ring configured to be mounted within the coronal O-ring housing; and
a second O-ring configured to be mounted within the apical O-ring housing.

3. The dental implant system of claim 1, wherein the dental implant includes a threaded bore extending from a coronal surface of the surface structure toward the apical end of the body portion.

4. The dental implant system of claim 1, wherein the superstructure extends from a coronal surface of the body portion.

5. The dental implant system of claim 1, wherein a stop surface is formed between an edge of the coronal surface and the superstructure, the stop surface configured to engage an apical end of the final prosthesis.

6. The dental implant system of claim 5, wherein the final prosthesis is a crown.

7. The dental implant system of claim 1, wherein at least a surface of the superstructure is roughened via acid-etching.

8. The dental implant system of claim 1, wherein the body portion of the superstructure includes two flat surfaces.

9. The dental implant system of claim 8, wherein the two flat surfaces are diametrically opposed to each other.

10. The dental implant system of claim 1, further including:
a retention screw configured to couple a final prosthesis to the dental implant, the retention screw having a head, a shank, and a threaded body configured to engage a threaded bore of the implant.

11. The dental implant system of claim 10, further including:
a short screw configured to plug a threaded bore of the implant when securing a final prosthesis to the dental implant via cement.

12. The dental implant system of claim 11, wherein the short screw has a length that is less than a length of the retention screw.

13. The dental implant system of claim 11, further including:
a dental implant analog corresponding to the dental implant; and
an indicator tube, the indicator tube having one opening at the coronal end, a plurality of perforations extending from an apical end toward the coronal end, and a plurality of graduated marks, wherein the indicator tube and the dental implant analog can be used to confirm a proper seating of a final prosthesis before coupling the final prosthesis to a patient.

14. A dental implant system, comprising:
a dental implant including:
a threaded body portion; and
a superstructure extending from the body portion, the superstructure including two O-ring housing spaced apart by a body portion including two flat surfaces.

15. The dental implant system of claim 14, further including:
a first O-ring configured to be mounted within a first O-ring housing of the two O-ring housings; and
a second O-ring configured to be mounted within a second O-ring housing of the two O-ring housings.

16. The dental implant system of claim 14, further including:
a first screw configured to be used to couple a final prosthesis to the dental implant; and
a second screw configured to be used when a final prosthesis is coupled to the dental implant via cement, wherein one or more dimensions of the first screw are different form the second screw.

17. The dental implant system of claim 14, further including:
a dental implant analog corresponding to the dental implant; and
an indicator tube, the indicator tube having one opening at the coronal end, a plurality of perforations extending from an apical end toward the coronal end, and a plurality of graduated marks, wherein the indicator tube and the dental implant analog can be used to confirm a proper seating of a final prosthesis before coupling the final prosthesis to a patient.

18. A method of developing a final prosthesis, the method including:
installing a dental implant into a jawbone of a patient, the dental implant including:
a threaded body portion; and
a superstructure extending from the body portion, the superstructure including two O-ring housing spaced apart by a body portion including two flat surfaces, wherein the threaded body portion is positioned within bone and the superstructure is positioned beneath a top gingival surface;
attaching a healing abutment to the dental implant, the healing abutment including information that allows identification of at least two characteristics of the dental implant;
creating a three-dimensional computer model from a scan of at least a portion of the mouth including the healing abutment;
based on the information from the healing abutment, modifying the three-dimensional computer model so as to include a three-dimensional computer model of at least a portion of the dental implant to be used in creating the prosthesis; and
designing a three-dimensional computer model of the prosthesis form the modified three-dimensional model.

19. The method of claim 18, wherein the portion of the three-dimensional computer model of at least the portion of the dental implant includes the superstructure and a coronal surface of the threaded body portion.

20. The method of claim 18, further including:
transmitting at least a portion of the designed three-dimensional computer model of the prosthesis to a milling machine capable of producing at least a portion of the prosthesis.
